(19) United States
(12) Patent Application Publication
(10) Pub. No.: US 2025/0369655 A1
(43) Pub. Date: Dec. 4, 2025

(54) SOLAR COLLECTOR ARRANGEMENT

(71) Applicant: University of Pretoria, Pretoria (ZA)

(72) Inventors: Willem Gabriel Le Roux, Muckleneuk, Pretoria (ZA); Casey Roosendaal, Cullinan (ZA); Jonathan Kyle Swanepoel, Pretoria (ZA)

(21) Appl. No.: 18/874,470

(22) PCT Filed: Jun. 9, 2023
(86) PCT No.: PCT/IB2023/055974

§ 371 Date: Dec. 12, 2024

(30) Foreign Application Priority Data
Jun. 13, 2022 (ZA) 202206501

(51) Int. Cl. F24S 30/45; F24S 20/20; F24S 23/70; F24S 23/71; F24S 30/20; F24S 50/20; F24S 50/60

(52) U.S. Cl. CPC F24S 30/45; F24S 20/20; F24S 23/71; F24S 30/20; F24S 50/20; F24S 50/60; F24S 2020/23; F24S 2023/832; F24S 2023/833; F24S 2023/874

(57) ABSTRACT

The invention provides a solar collector arrangement which includes a reflector (12), a collector (14) and a support arrangement (16). The support arrangement is configured to permit relative displacement of the reflector and the collector between an operative condition, in which the collector is positioned to receive reflected radiation from the reflector, and a stowed condition. In the stowed condition, the spacing between the reflector and the collector is less than in the operative condition and the wind loading on the solar collector arrangement is less than in the operative condition. The invention extends to a solar assembly which includes a mobile platform on which the solar collector arrangement is mounted.

This invention relates to solar energy. More particularly it relates to a solar collector arrangement. It further relates to a solar assembly.

The inventors are aware of solar collector arrangements which comprise a solar dish or reflector and a receiver which is mounted to receive concentrated radiation reflected from the solar dish. To this end, the receiver is mounted at a fixed position relative to the reflector which is typically coincident with the focal point of the reflector.

To optimise the harvesting of solar energy the reflector and receiver are secured together in a fixed spatial arrangement as an assembly which is typically mounted for angular displacement about vertical and horizontal axes to enable the reflector to follow the path of the sun.

In certain circumstances, e.g., in high wind conditions, the reflector and receiver assembly is displaced to a stowed condition in which the reflector faces downwardly and the receiver is positioned below the reflector. A problem with this arrangement is that this requires the reflector and receiver assembly to be mounted on a tower which is tall enough to ensure that when in the stowed condition the reflector is spaced far enough from the ground to provide sufficient clearance for the receiver to be positioned between the reflector and the ground. This results in substantial wind loading of the solar collector arrangement both when in its operative condition and in its stowed condition. In addition, construction costs are increased as a result of the height and strength of the tower required to support the reflector and receiver assembly.

It is an object of this invention to provide means which the Inventors believe will at least alleviate this problem or provide a useful alternative.

According to one aspect of the invention there is provided a solar collector arrangement which includes:
a reflector;
a receiver; and
a support arrangement which is configured to permit relative displacement of the reflector and receiver between an operative condition in which the receiver is positioned to receive reflected radiation from the reflector and a stowed condition.

In the stowed condition, the spacing between the reflector and the receiver may be less than in the operative condition.

In the stowed condition, the wind loading on the solar collector arrangement may be less than in the operative condition.

The support arrangement may be configured to permit angular displacement of the reflector and receiver relative to one another between the stowed condition and the operative condition. To this end, the support arrangement may include a support structure to which at least one of the reflector and the receiver is pivotally connected by means of a pivotal connection for displacement about a first pivot axis between the operative and stowed conditions. In one embodiment of the invention, the reflector is pivotally connected to the support structure and the support arrangement may include an actuator whereby the reflector is displaceable relative to the support structure between its operative and stowed conditions. In one embodiment of the invention, the actuator may include a pressurised fluid operated piston and cylinder assembly. In another embodiment of the invention, the actuator may be electrically operated or alternatively a combination of hydraulic and electrical actuation. In yet another embodiment of the invention, the reflector is displaceable relative to the support structure by means of a torque tube which can be rotated, e.g., electrically, or hydraulically.

The solar collector arrangement may include a base which is rotatable about a vertical axis of rotation, the support arrangement being pivotally mounted on the base for angular displacement about a second pivot axis.

The first and second pivot axes may be parallel.

The support structure may include an elongate first support arm, one end of which is connected to the base, the receiver being mounted to the first support arm at or adjacent the other end thereof and a second support arm which is angularly spaced from the first support arm and to which the reflector is connected.

The reflector may be of composite construction and comprise a plurality of reflector elements. Each of at least some of the reflector elements may be parabolic in shape and have a focal point which is coincident with the receiver when the reflector is in its operative condition.

The receiver may be configured to heat a fluid. To this end, the receiver may include an inlet for receiving fluid to be heated and an outlet which is in fluid communication with the inlet, and through which heated fluid can be discharged from the receiver, in use.

In another embodiment of the invention the receiver may be configured to heat a solid.

According to another aspect of the invention, there is provided a solar assembly which includes:
a mobile platform; and
a solar collector arrangement as described above which is mounted on the mobile platform for displacement from one location to another.

The mobile platform may be in the form of a trailer which is disconnectably connectable to a draught vehicle.

The invention will now be described, by way of example, with reference to the accompanying diagrammatic drawings.

In the drawings:

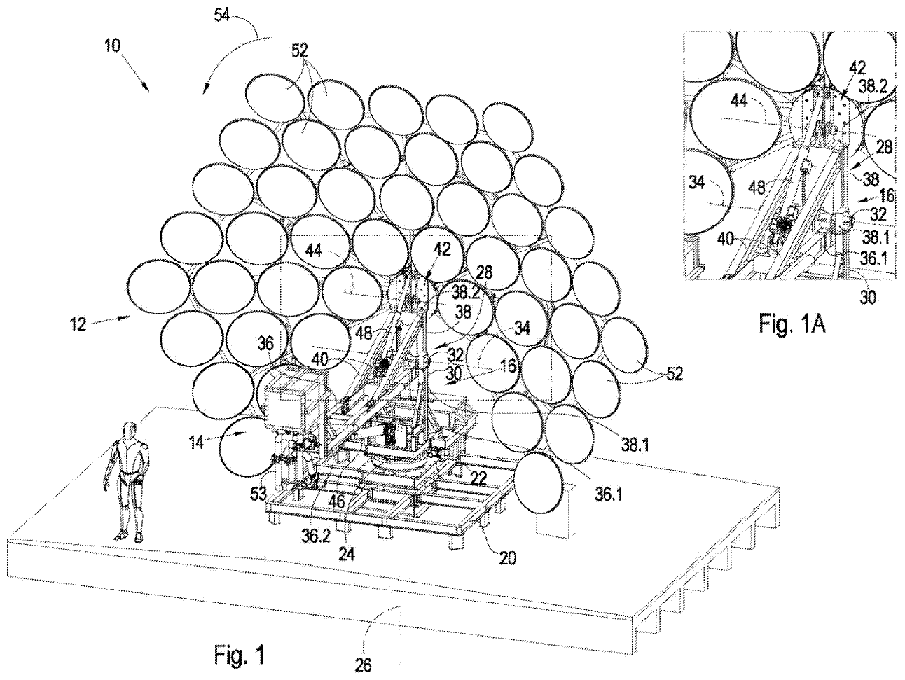

FIG. 1 shows a three-dimensional view of a solar collector arrangement in accordance with the invention in an operative condition and in a first position;

FIG. 1A shows an enlarged view of part of the solar collector arrangement of FIG. 1;

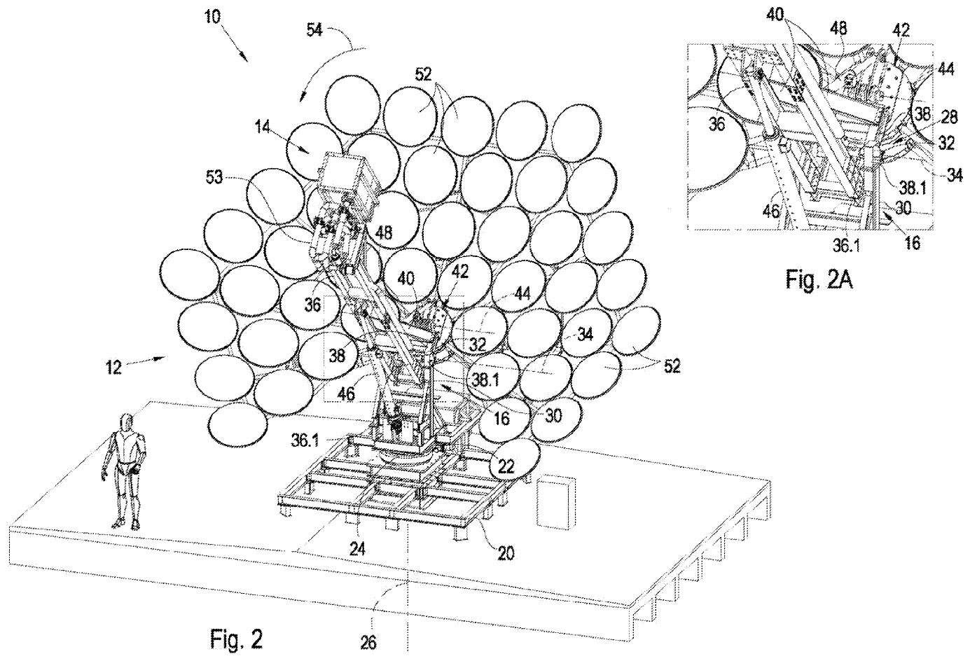

FIG. 2 shows a three-dimensional view of the solar collector arrangement of FIG. 1 in a second position;

FIG. 2A shows an enlarged view of part of the solar collector arrangement of FIG. 2;

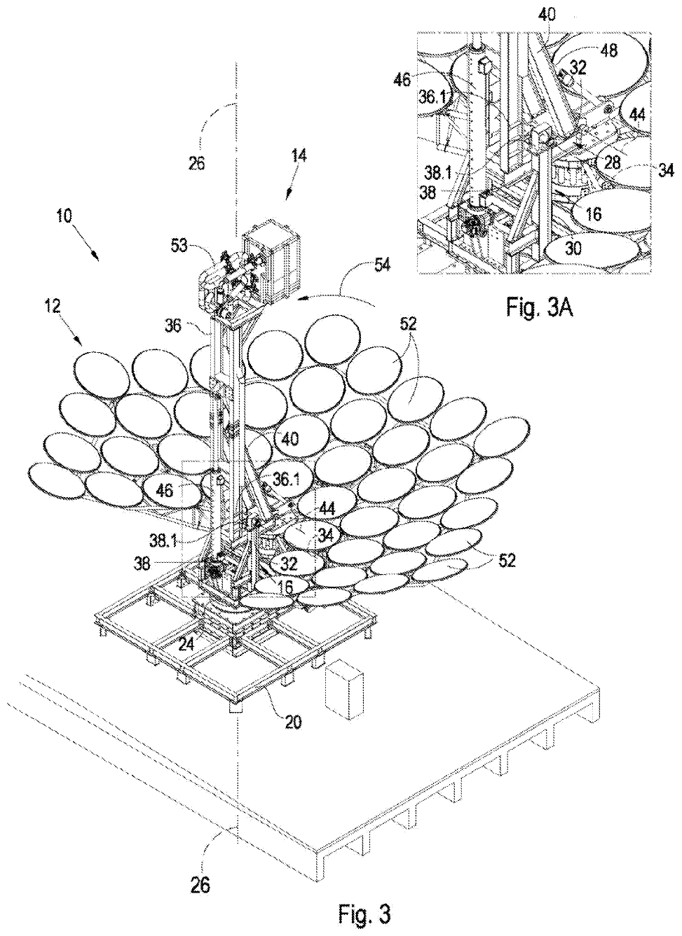

FIG. 3 shows a three-dimensional view of the solar collector arrangement of FIG. 1 in a third position;

FIG. 3A shows an enlarged view of part of the solar collector arrangement of FIG. 3;

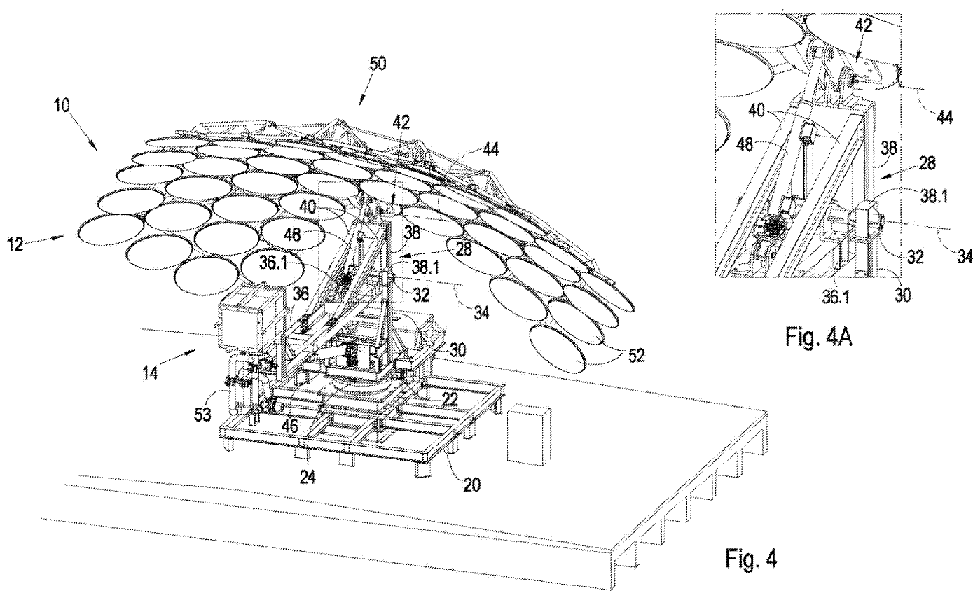

FIG. 4 shows a three-dimensional view of the solar collector arrangement of FIG. 1 in a partially stowed condition;

FIG. 4A shows an enlarged view of part of the solar collector arrangement of FIG. 4;

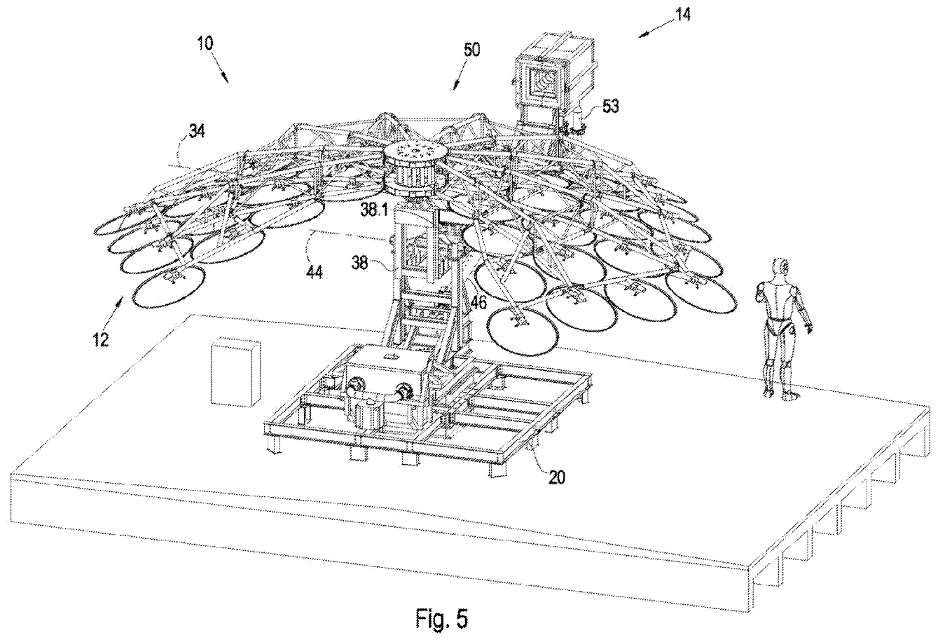

FIG. 5 shows a three-dimensional view of the solar collector arrangement of FIG. 4 viewed from the opposite side in its stowed condition;

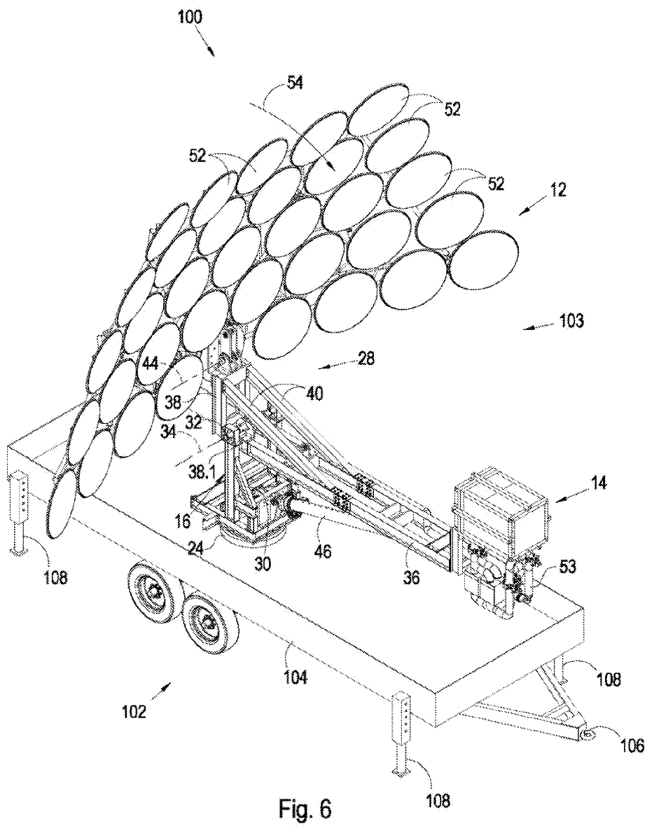

FIG. 6 shows a three-dimensional view of a solar assembly in accordance with the invention with a solar collector arrangement of the solar assembly in an operative condition;

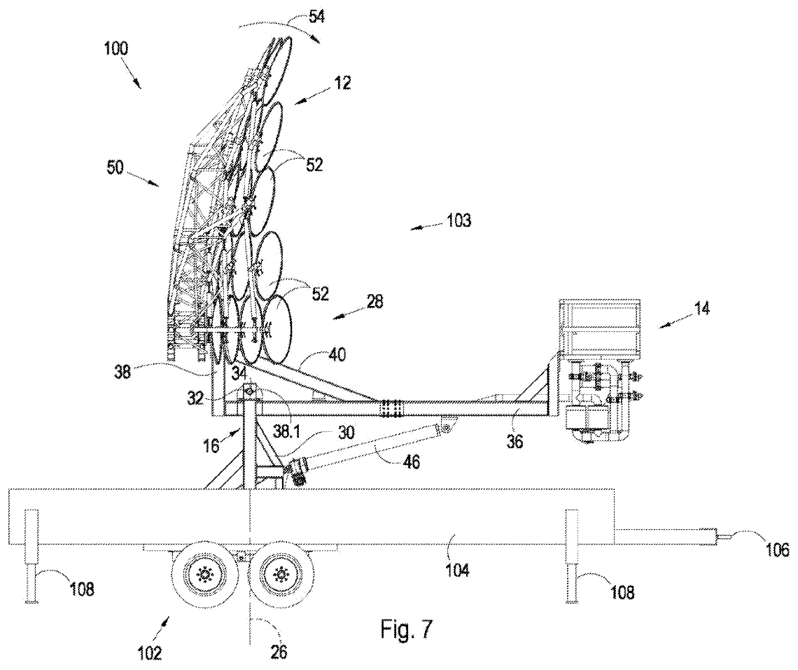

FIG. 7 shows a side view of the solar assembly of FIG. 6;

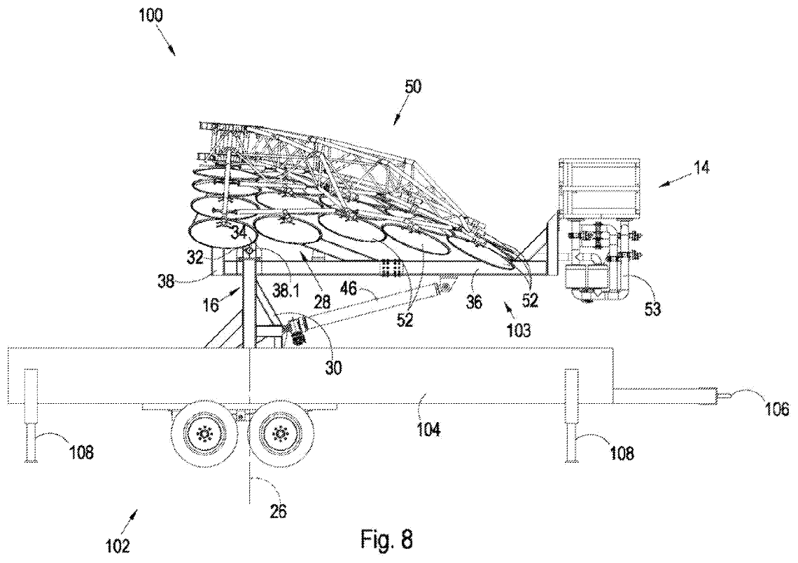

FIG. 8 shows a side view, similar to FIG. 7, with the solar collector arrangement in a first stowed condition; and

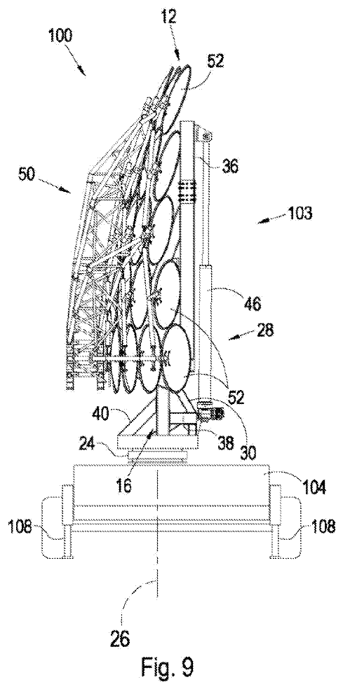

FIG. 9 shows a rear view of the solar assembly of FIG. 6 with the solar collector arrangement in a second stowed or transport condition.

### DETAILED DESCRIPTION OF AN EXAMPLE EMBODIMENT

The following description of the invention is provided as an enabling teaching of the invention. Those skilled in the relevant art will recognise that many changes can be made to the embodiments described, while still attaining the beneficial results of the present invention. It will also be apparent that some of the desired benefits of the present invention can be attained by selecting some of the features of the present invention without utilising other features. Accordingly, those skilled in the art will recognise that modifications and adaptations to the present invention are possible and can even be desirable in certain circumstances and are a part of the present invention. Thus, the following description is provided as illustrative of the principles of the present invention and not a limitation thereof.

In FIGS. 1 to 5 of the drawings, reference numeral 10 refers generally to a solar collector arrangement in accordance with the invention. The solar collector arrangement 10 includes a reflector, generally indicated by reference numeral 12, a collector or receiver, generally indicated by reference numeral 14, and a support arrangement, generally indicated by reference numeral 16.

The support arrangement 16 includes a base 20 on which a turntable 22 is mounted, the turntable 22 including a top 24 which is rotatable about an axis of rotation 26 which extends vertically.

The support arrangement 16 further includes a support structure, generally indicated by reference numeral 28, which is mounted on the top 24 of the turntable 22. The support arrangement 16 includes an upright support 30 which is mounted on the top 24 of the turntable 22 and extends vertically upwardly therefrom. The support structure 28 is pivotally connected to an upper end of the upright support 30 by pivot pins 32 which permit pivotal displacement of the support structure 28 relative to the upright support 30 about a horizontal pivot axis 34. The support structure 28 includes an elongate boom 36 having a proximal end 36.1 and a distal end 36.2. Further, the support structure 28 includes a reflector support arm 38 having a proximal end 38.1 and a distal end 38.2. The proximal ends 36.1, 38.1 of the boom 36 and reflector support arm 38 are connected together such that the boom 36 and reflector support arm 38 extend away from their connection perpendicular to one another. A pair of bracing or support struts 40 extend between the boom 36 and support arm 38 to secure them together.

The receiver 14 is mounted on the boom 36 at or towards the distal end 36.2 thereof. The reflector 12 is connected by means of a pivotal connection 42 to the distal end 38.2 of the support arm 38 for pivotal displacement about a horizontal pivot axis 44. Displacement of the support structure 28 relative to the upright support 30 about the pivot axis 34 is effected, in the embodiment shown, by means of a pressurised fluid operated piston and cylinder assembly 46 which is connected to and extends between the upright support 30 and the boom 36. Alternatively, displacement of the support structure 28 relative to the upright support 30 about the pivot axis 34 could be effected by means of an electrical actuator, e.g., a motor gearbox combination. Pivotal displacement of the reflector 12 relative to the support structure 28 about the pivot axis 44 is effected by a piston and cylinder arrangement 48 which is connected to and extends between the reflector 12 and the support structure 28. Similarly, instead of the piston and cylinder arrangement 48, use could be made of an electrical actuator, e.g., a motor gearbox combination. As can be seen in the drawings, the connection of the piston and cylinder arrangement 48 to the reflector 12 is at a position spaced from the connection of the pivotal connection of the reflector 12 to the support arm 38 to provide the requisite torque to displace the reflector 12 as described in more detail below.

It will be appreciated that one or more of the turntable 22, piston and cylinder assembly 46 and the piston and cylinder arrangement 48 could be replaced with an alternative drive arrangement such as a slew drive such as that available from Bearings Distributors (Pty) Ltd.

In the embodiment shown, the reflector 12 is a composite reflector and comprises a support frame 50 to which a plurality of reflector elements 52 is connected at spaced apart positions. Each reflector element 52 is typically parabolic in shape and positioned such that a focal point of the reflector element is coincident with the receiver 14 when the reflector is in the operative condition shown in FIGS. 1 to 3 of the drawings.

In the embodiment shown, the receiver 14 is configured to heat a fluid. To this end, the receiver 14 includes an inlet for receiving fluid to be heated and an outlet which is in fluid communication with the inlet, and through which heated fluid can be discharged from the receiver, in use. Piping 53 is provided in order to feed fluid to be heated to the inlet and to feed heated fluid to a desired location, e.g., to be used as process heat or for power generation. In one application the heated fluid is used for the melting of metals, e.g., for processing, manufacturing or recycling. In another embodiment of the invention, the receiver 14 is configured to heat up or melt a solid (direct or indirect heating of a solid piece or multiple pieces of metal for example).

In use, when the solar collector arrangement 10 is in its operative condition shown in FIGS. 1 to 3 of the drawings, it is used in a conventional fashion and is displaceable about the vertical axis of rotation 26 and the pivot axis 34 which extends horizontally to follow the path of the sun and maximise the collection of radiation on the collector. Hence, in FIG. 1 of the drawings, the sun would be relatively low to the horizon, e.g., early in the morning.

When it is desired to displace the solar collector arrangement into a stowed condition, e.g., during high winds and/or in low light conditions such as at night-time, the piston and cylinder arrangement 48 is operated in order to displace the reflector 12 in the direction of arrow 54 (FIG. 1) about the pivot axis 44 formed by the pivotal connection 42. As can be seen in FIGS. 4 and 5 of the drawings, the reflector 12 is displaced through approximately 90° from its operative condition (shown in FIGS. 1 to 3 of the drawings) to its stowed condition (shown in FIG. 5 of the drawings). Naturally, to return the reflector to its operative condition, the reverse procedure is followed.

It will be appreciated that the total height of the solar collector arrangement 10 is reduced substantially when in its stowed condition. In addition, the reflector 12 extends generally parallel to the ground thereby effectively decreasing the surface area of the reflector 12 which would be exposed to any wind loading. This could occur naturally, e.g., during high wind speeds conditions, rainstorms or the like. Besides minimising loading on the support structure during high wind speed conditions, the reflector stow feature also protects the sensitive reflector facets/elements from being damaged due to environmental exposure from above, e.g., during hailstorms, dust storms, or the like.

Another advantage with being able to place the collector in a stowed condition is that the reflector facets/elements face downwards towards the ground which allows for more effective cleaning and maintenance of the reflector elements.

Further, by virtue of the fact that the boom 36 and receiver 14 are not displaced together with the reflector 12 when displacing the reflector to its stowed condition, the height of the upright support 30 need only be sufficiently high to provide clearance between the lowest edge of the reflector 12 and the boom 36 and the ground during normal use. This reduced height of the solar collector arrangement when compared with prior art solar collector arrangements of which the Inventors are aware, once again substantially reduces wind loading on the solar collector arrangement both when in its operative and stowed conditions.

Reference is now made to FIGS. 6 to 9 of the drawings, in which reference numeral 100 refers generally to a solar assembly in accordance with the invention.

The solar assembly 100 includes a mobile platform, generally indicated by reference numeral 102 and a solar collector arrangement, generally indicated by reference numeral 103, mounted on the mobile platform 102.

In the embodiment shown, the mobile platform 102 is in the form of a trailer comprising a wheeled chassis 104 having a hitch 106 whereby the trailer 102 is disconnectably disconnectable to a draught vehicle.

The solar collector arrangement 103 which is mounted on the trailer 102 is similar to the solar collector arrangement 10 shown in FIGS. 1 to 5 of the drawings and described above and, unless otherwise indicated, the same reference numerals used above are used to designate similar parts. The main difference between the solar collector arrangement 103 and the solar collector arrangement 10 is that the reflector 12 of the solar collector arrangement 103 makes use of fewer reflector elements 52. It will be appreciated, however, that depending on the intended application the reflector could include more or fewer reflector elements.

In the embodiment shown, the trailer 102 includes four telescopic legs 108 which can be deployed in order to stabilise the trailer 102 when located at a desired position. It will be appreciated, that more or fewer legs could be used.

The solar assembly 100, with the telescopic legs 108 in a retracted condition, can be transported to any desired location. At the desired location, the telescopic legs 108 are extended such that they abut against the ground and support the trailer 104 in a stable manner and such that the axis of rotation 26 extends vertically. The solar collector arrangement 103 can then be used in substantially the identical manner to the solar collector arrangement 10 described above.

When it is desired to displace the solar collector arrangement 103 into a stowed condition, e.g., during high winds and/or in low light conditions such as at night-time, the reflector 12 is displaced in the manner described above into the stowed condition shown in FIG. 8 of the drawings. When it is desired to return the solar collector arrangement 103 to its operative condition, the reverse procedure is followed.

It will be appreciated, however, that in the stowed condition shown in FIG. 8 of the drawings, the reflector 12 will protrude laterally beyond the sides of the trailer 102. Accordingly, when it is desired to transport the trailer from one location to another, the solar collector arrangement can be displaced into a transport or second stowed condition, shown in FIG. 9 of the drawings, in which the reflector extends generally longitudinally relative to the trailer 102 and does not protrude beyond the edges of the trailer.

In this arrangement, the wind loading on the solar connector due to the movement of the trailer is also restricted which not only mitigates strain from wind speeds but also provides a compact profile that allows it to be transported on public roads.

1. A solar collector arrangement which includes:
a reflector;
a receiver; and
a support arrangement which is configured to permit relative displacement of the reflector and receiver between an operative condition in which the receiver is positioned to receive reflected radiation from the reflector and a stowed condition.

2. The solar collector arrangement as claimed in claim 1, in which, in the stowed condition, the spacing between the reflector and the receiver is less than in the operative condition.

3. The solar collector arrangement as claimed in claim 1, in which, in the stowed condition, the wind loading on the solar collector arrangement is less than in the operative condition.

4. The solar collector arrangement as claimed in claim 1, in which the support arrangement is configured to permit angular displacement of the reflector and receiver relative to one another between the stowed condition and the operative condition.

5. The solar collector arrangement as claimed in claim 4, in which, in the stowed condition, the angular spacing between the reflector and the receiver is less than the angular spacing between the reflector and the receiver when in the operative condition.

6. The solar collector arrangement of claim 4, in which the support arrangement includes a support structure to which at least one of the reflector and the receiver is pivotally connected by means of a pivotal connection for displacement about a first pivot axis between the operative and stowed conditions.

7. The solar collector arrangement as claimed in claim 6, in which the reflector is pivotally connected to the support structure and the support arrangement includes an actuator whereby the reflector is displaceable relative to the support structure between its operative and stowed conditions.

8. The solar collector arrangement as claimed in claim 7, in which the actuator includes a pressurized fluid operated piston and cylinder assembly.

9. The solar collector arrangement as claimed in claim 7, in which the actuator is electrically operated.

10. The solar collector arrangement as claimed in claim 6, which includes a base which is rotatable about a vertical axis of rotation, the support arrangement being pivotally mounted on the base for angular displacement about a second pivot axis.

11. The solar collector arrangement as claimed in claim 10, in which the first and second pivot axes are parallel.

12. The solar collector arrangement as claimed in claim 10, in which the support structure includes an elongate first support arm, one end of which is connected to the base, the receiver being mounted to the first support arm at or adjacent the other end thereof and a second support arm which is angularly spaced from the first support arm and to which the reflector is connected.

13. The solar collector arrangement as claimed in claim 1, in which the reflector is of composite construction and comprises a plurality of reflector elements.

14. The solar collector arrangement as claimed in claim 13, in which each of at least some of the reflector elements is parabolic in shape and has a focal point which is coincident with the receiver when the reflector is in its operative condition.

15. The solar collector arrangement as claimed in claim 1, in which the receiver is configured to heat a fluid, the receiver including an inlet for receiving fluid to be heated and an outlet which is in fluid communication with the inlet, and through which heated fluid can be discharged from the receiver, in use.

16. The solar collector arrangement as claimed in claim 1, in which the receiver is configured to heat a solid.

17. A solar assembly which includes:
a mobile platform; and
a solar collector arrangement as claimed in claim 1 which is mounted on the mobile platform for displacement from one location to another.

18. The solar assembly as claimed in claim 17, in which the mobile platform is in the form of a trailer which is disconnectably connectable to a draught vehicle.
